(19) United States
(12) Patent Application Publication
(10) Pub. No.: US 2009/0288685 A1
(43) Pub. Date: Nov. 26, 2009

(54) SELF-PROPELLED EXTRACTION SYSTEMS AND METHODS

(76) Inventors: Kevin A. Wolfe, Burlington, WA (US); Brett Bartholmey, Bellingham, WA (US)

Correspondence Address: PERKINS COIE LLP;PATENT-SEA, P.O. BOX 1247, SEATTLE, WA, 98111-1247, US

(21) Appl. No.: 12/419,615

(22) Filed: Apr. 7, 2009

Related U.S. Application Data
(63) Continuation of application No. 11/897,428, filed on Aug. 29, 2007, now abandoned.
(60) Provisional application No. 60/845,012, filed on Sep. 14, 2006.

(51) Int. Cl. A47L 9/00; B08B 5/04

(52) U.S. Cl. 134/21; 15/339

(57) ABSTRACT

A system for applying a vacuum to a floor structure, a platform assembly for allowing a user to extract fluids from a floor structure, a system for extracting invasive liquids from a floor structure, a drive system for allowing a user standing on a platform assembly to displace the platform assembly along a floor surface, and/or A method of applying a vacuum to a floor structure.

### RELATED APPLICATIONS

This application claims priority of U.S. Provisional Patent Application Ser. No. 60/845,012 filed Sep. 14, 2006, the contents of which are incorporated herein by reference.

### TECHNICAL FIELD

The present invention relates to systems and methods for extracting fluids from flooring materials and, more particularly, to self-propelled extraction systems and methods adapted to carry the operator.

### BACKGROUND OF THE INVENTION

Water and other liquids are often introduced into buildings by floods, sprinkler systems, plumbing and sewer leaks, and the like. In the following discussion, the term “invasive liquid” will refer to any liquid that inadvertently or undesirably enters or remains in a building.

In many cases, if the invasive liquid is not immediately removed, permanent damage to the building or its contents may occur. For example, a carpet that is soaked with water may create an environment that nurtures the growth of molds and mildew. Such molds and mildew can, at a minimum, create undesirable odors and in some situations can pose health risks for the building's occupants. Conventionally, if a floor covering, wall covering, or building structure became damaged because of inadequate drying, the damaged item must be removed and replaced, often at considerable expense.

To avoid the expense of repairing water damaged buildings and their contents, a number of systems and methods have been developed for use by restorative drying professionals to remove invasive liquids from buildings. Restorative drying systems can be as simple as a blower that forces air over a surface to be dried or as complex as a dehumidifier that extracts water from air to enhance conditions conducive to drying. Often, a number of systems are used together in one complete system that is tailored to a specific situation.

The present invention relates to the specific problem of removing invasive liquids from floor coverings such as carpets, rugs, hardwood, linoleum, vinyl, and the like. Often, the floor covering can trap the invasive liquid in a manner that prevents or slows down the drying of the overall floor structure using conventional restorative drying systems and methods.

The need thus exists for improved systems and methods for extracting water and other invasive liquids from floor coverings such as carpets.

### RELATED ART

U.S. Pat. No. 6,355,112 to Bartholomey discloses systems and methods of extracting fluid from a floor surface comprising an extraction tool, an extraction head, a drive roller assembly. The extraction tool has a frame assembly defining a support surface. The extraction head is mounted to the frame assembly and includes an extraction opening that engages with the floor surface. The drive roller assembly is mounted to the frame assembly and engages the floor surface. The operator stands on the support surface between the extraction head and the drive roller assembly such that the weight of the user on the support surface is transferred to the extraction head or the drive roller assembly. The drive roller assembly is operated to propel the extraction tool along the floor surface. Fluid is extracted from the floor surface through the extraction opening. The speed of the extraction tool across the floor surface is controlled by shifting the user's weight on the support surface such that movement of the user's weight towards the extraction head increases friction between the floor surface and the extraction head resulting in a decrease in speed of the extraction tool and movement of the user's weight towards the drive roller assembly results in an increase in speed of the extraction tool across the floor surface.

U.S. Pat. No. 5,357,650 to Finley discloses a carpet water extractor employing two rear wheels, a front roller, and a vacuum chamber having an inlet arranged immediately behind the front roller. The Finley device is pulled along a wet carpet such that water pools up behind the roller and enters the vacuum chamber inlet. Weights are arranged above the front roller to assist in forcing or squeezing water out of the carpet. The rear wheels are preferably powered to assist movement of the device.

U.S. Pat. No. 6,152,151 to Bolden discloses a carpet water extractor employing a roller enclosed within a vacuum chamber. The roller compresses the carpet such that water therein may be removed by air flowing through the vacuum chamber. Holes are preferably formed in the roller purportedly to prevent waves in front of the roller by allowing water to enter the interior of the roller.

U.S. Pat. No. 5,463,791 to Roden discloses a floor surface cleaner that may be used to remove water from floor materials. The Roden device employs two heads that rotate about vertical axes such that the coverage of the heads overlaps. This device is preferably configured as a cleaning device with spray nozzles in addition to vacuum nozzles.

U.S. Pat. Nos. 4,264,999, 4,441,229, 4,692,959, 4,333,204, and 4,339,840 to Monson all disclose a carpet cleaner that could be used to remove water from carpets and the like. The Monson device employs an internal head assembly mounted within a shroud. Vacuum nozzles are mounted on the head assembly and rotate relative to the floor surface.

The Applicant is also aware of a number of other systems and methods for removing invasive liquids from floor coverings. Some of these systems and methods are not designed for restorative drying while other have been developed specifically for use by restorative drying professionals.

Carpet cleaning wands are connected to a vacuum and may be used to extract water from carpets. The assignee of the present invention sells a roller that is pushed across a carpet to force water out of the carpet for removal by a separate system such as a carpet cleaning system or wet/dry vac. Rollers are also used to push water into a fixed pan from which the water may be removed by vacuuming or dumping.

Another type of device comprises platform defining a plenum formed between upper and lower sheets of material such as plastic. Holes are formed in the lower sheet of material, and the plenum is connected to a vacuum device. The platform is placed on the floor, and the user stands on the platform and operates the vacuum device. The user's weight forces water from the carpet through the holes into the plenum where it is removed by the vacuum device. This type of device does not have wheels and must be lifted to be moved from place to place.

The Applicant is also aware of a device employing a solid roller arranged within a housing. A vacuum is established within the housing. The device is pushed across the floor such that the roller squeezes water out of the carpet for extraction by the vacuum within the housing. This device is similar to the device disclosed in the Bolden patent cited above but does not employ holes formed in the roller to prevent waves by allowing water to flow into the interior of the roller.

One class of water extraction devices not specifically designed for use by restorative drying professionals includes industrial and residential carpet cleaning devices. Carpet cleaning devices spray water and detergent onto a carpet adjacent to a suction head. The suction head is drawn or pushed over the sprayed section of carpet to remove the water, detergent, and dirt or debris in the carpet. The suction head is normally a hollow member that defines a plenum adjacent to an elongate slot. The plenum is connected to a vacuum device that causes air and entrained invasive liquid to be drawn through the slot and the plenum and into a reservoir of the vacuum device. Carpet cleaning devices thus differ from devices used by restorative drying professionals in that the carpet cleaning devices first introduce liquids into the floor covering before removing this liquid.

A similar structure is used by a class of products commonly referred to as wet/dry vacs; wet/dry vacs are general purpose devices not specifically designed for use by restorative drying professionals. A conventional wet/dry vac comprises a suction head and a vacuum device defining a reservoir for containing liquids entrained in the air drawn through the suction head. Except for the liquid reservoir and the materials used in bringing the air/liquid to the reservoir, the basic design of a wet/dry vac is similar to that of a canister-style vacuum cleaner.

### SUMMARY OF THE INVENTION

The principles of the present invention may be embodied as a system for applying a vacuum to a floor structure, comprising a vacuum system, a vacuum hose, and a vacuum accessory. The vacuum system creates at least a partial vacuum. The vacuum hose is operatively connected to the vacuum system. The vacuum accessory comprises a platform assembly and a drive system. The platform assembly comprises at least one inlet opening directed to a portion of the floor structure and an outlet opening operatively connected to the vacuum hose. The drive system comprises a control member and first and second drive wheels. Displacement of the control member causes movement of the first and second drive wheels which in turn causes the platform assembly to move in at least one of a forward direction, a reverse direction, a first pivot direction, and a second pivot direction. As the platform assembly moves in at least one of a forward direction, a reverse direction, a first pivot direction, and a second pivot direction, the inlet opening moves along a path relative to the floor structure.

The principles of the present invention may also be embodied as a platform assembly for allowing a user to extract fluids from a floor structure, comprising a deck structure, a frame structure, and an inlet assembly. The deck structure defines a surface on which the user stands. The frame structure supports the deck structure and at least one drive wheel for propelling the platform assembly. The inlet assembly comprises an inlet housing defining a housing chamber, an inlet pipe defining a pipe chamber, and an inlet member defining a plurality of inlet openings. The inlet housing is supported by the deck structure. The inlet pipe is supported in a fixed position relative to the inlet housing. The inlet member is supported in a fixed position relative to the inlet housing. An inlet passageway extends through the inlet openings, the housing chamber, and the pipe chamber. In a use mode, the at least one drive wheel and the inlet member are in contact with the floor structure.

The principles of the present invention may also be embodied as a system for extracting invasive liquids from a floor structure comprising a platform assembly, a handle assembly extending from the platform assembly, and a drive system. The drive system comprises first and second drive wheels supported by the platform assembly and a control member supported by the handle assembly. Displacement of the control member causes the first and second drive wheels to rotate to cause the platform assembly to move in at least one of a forward direction, a reverse direction, a first pivot direction, and a second pivot direction.

The principles of the present invention may also be embodied as a drive system for allowing a user standing on a platform assembly to displace the platform assembly along a floor surface comprising at least first and second drive wheels and a joystick. The first and second drive wheels are supported by the platform assembly such that the first and second drive wheels engage the floor surface. The joystick is arranged such that the user standing on the platform assembly can displace the joystick in one or more of a forward direction, a reverse direction, a first side direction, and a second side direction. Displacement of the joystick in the forward direction causes the platform assembly to move in the forward direction. Displacement of the joystick in the reverse direction causes the platform assembly to move in the reverse direction. Displacement of the joystick in the first side direction causes the platform assembly to move in the first pivot direction. Displacement of the joystick in the second side direction causes the platform assembly to move in the second pivot direction.

The principles of the present invention may also be embodied as a method of applying a vacuum to a floor structure comprising the following steps. A vacuum system for creating at least a partial vacuum is provided. A platform assembly is provided that defines an outlet opening and at least one inlet opening directed to a portion of the floor structure. The vacuum hose is operatively connected to the vacuum system and the outlet opening. A drive system comprising a control member and first and second drive wheels is provided. The control member and the first and second drive wheels are arranged such that displacing the control member causes rotation of the first and second drive wheels. The first and second wheels are supported on the platform assembly and the first and second wheels are engaged with the floor structure such that rotation of the first and second drive wheels causes the platform assembly to move in at least one of a forward direction, a reverse direction, a first pivot direction, and a second pivot direction. Displacing the control member such that the platform assembly moves in at least one of a forward direction, a reverse direction, a first pivot direction, and a second pivot direction relative to the floor structure causes the inlet opening to move along a path relative to the floor structure.

### BRIEF DESCRIPTION OF THE DRAWINGS

FIG. 1 is a perspective view of a first embodiment of an extraction system of the present invention;

FIG. 2 is a side elevation view of a first example extraction device of the first example extraction system in a use mode;

FIG. 3 is a side elevation view of the first example extraction device in a storage mode;

FIG. 4 is a side elevation view of the first example extraction device is a transportation mode;

FIG. 5 is a bottom plan view of the first example extraction device;

FIG. 6 is a side elevation section view taken along lines 6-6 in FIG. 5 depicting a platform assembly and a drive system of the first example extraction device;

FIG. 7 is a detail of a portion of FIG. 6 depicting an example inlet portion that may be used by the first example extraction device;

FIG. 8 is a perspective view of a second embodiment of an extraction system of the present invention;

FIG. 9 is a side elevation view of a second example extraction device of the second example extraction system in a use mode;

FIG. 10 is a bottom plan view of the second example extraction device;

FIG. 11 is a side elevation section view depicting a platform assembly and a drive system of the second example extraction device; and

FIG. 12 is a detail of a portion of FIG. 12 depicting a first example inlet portion that may be used by the second example extraction device.

### DETAILED DESCRIPTION OF THE INVENTION

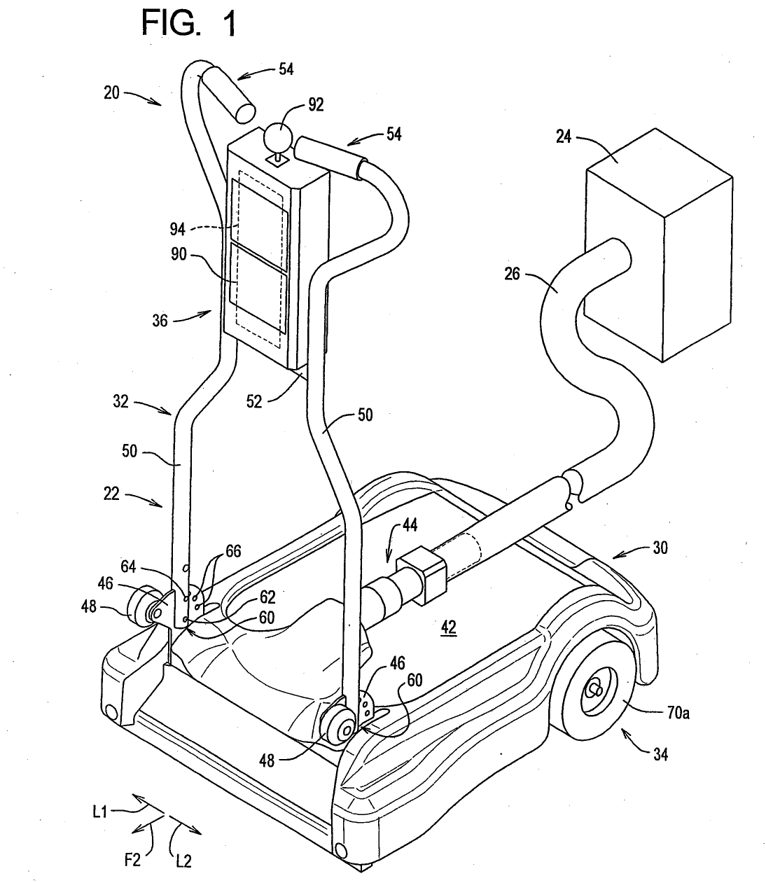

Referring initially to FIGS. 1-7 of the drawing, depicted therein is a first example extraction system 20 constructed in accordance with, and embodying, the principles of the present invention. The first example extraction system 20 comprises an extraction device 22, a vacuum system 24, and a vacuum hose 26. The vacuum system 24 and hose 26 are or may be conventional and will be described herein only to the extent necessary for a complete understanding of the present invention.

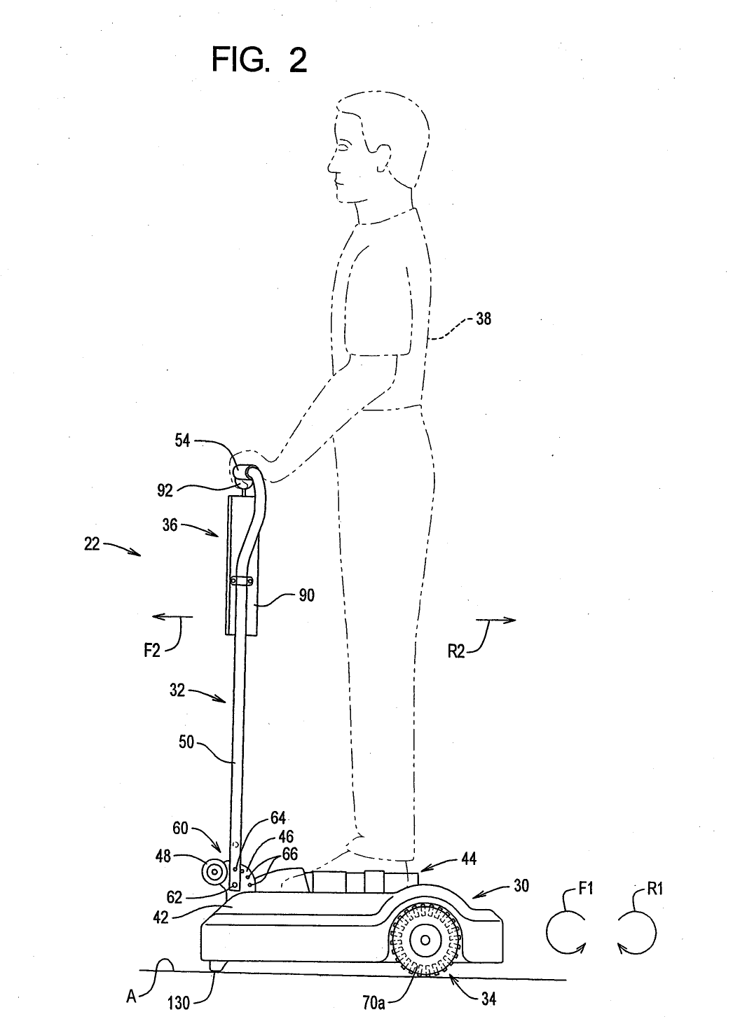

The first example extraction device 22 comprises a platform assembly 30, a handle assembly 32, a drive system 34, and a control system 36. The example extraction device 22 is shown in FIG. 2 in a use configuration. In this use configuration, the extraction device 22 may be placed in a use mode in which a user 38 stands on the platform assembly 30 and grips the handle assembly 32 while operating the control system 36 to cause the drive system 34 to displace the extraction device 22 along a surface A. When connected to the vacuum system 24 by the hose 26, liquids are extracted from flooring materials defining the surface A.

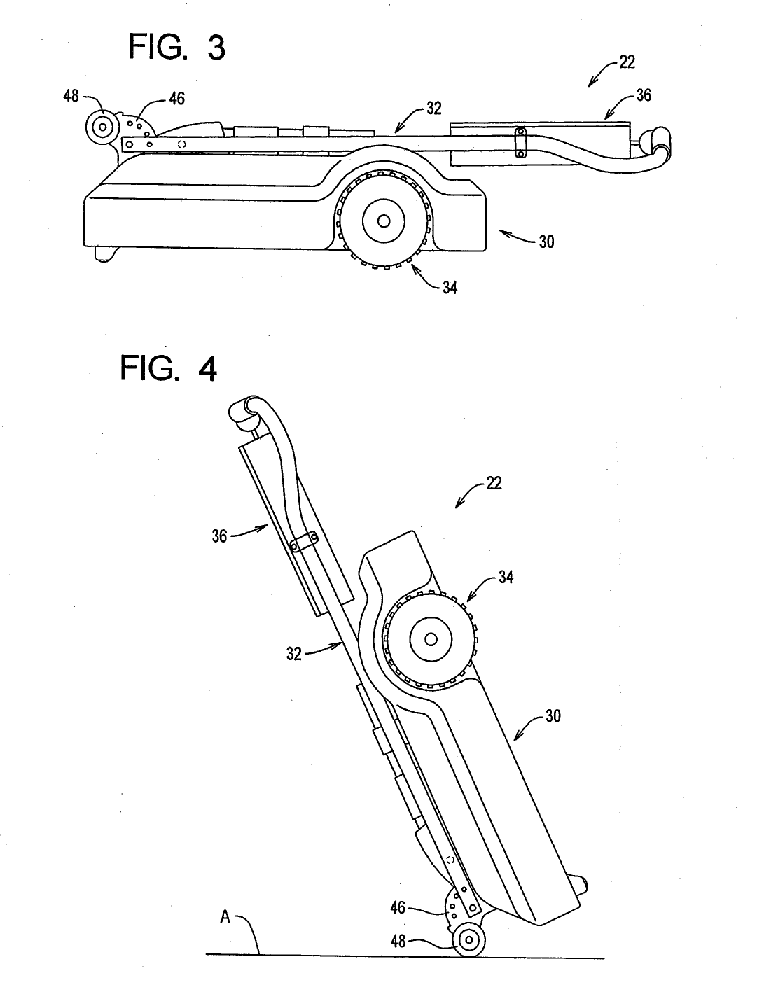

FIG. 3 illustrates the example extraction device 22 in a folded configuration in which an angle between the handle assembly 32 and the platform assembly 30 is changed. In this folded configuration, the extraction device 22 may be placed in a storage mode in which the device 22 effectively occupies a volume that is significantly smaller than that occupied by the extraction device 22 in the use configuration. When placed in the storage configuration, the extraction device 22 may be stored more conveniently than in the use configuration.

FIG. 4 illustrates the example extraction device 22, when placed in the folded configuration, may be placed in a transportation mode in which the device 22 may be easily displaced along the surface A while not operating.

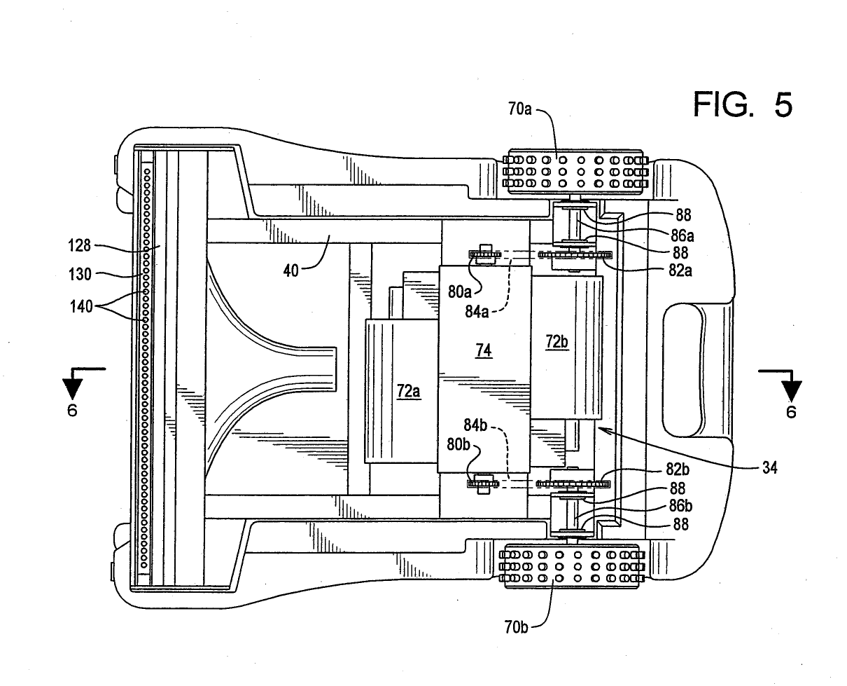

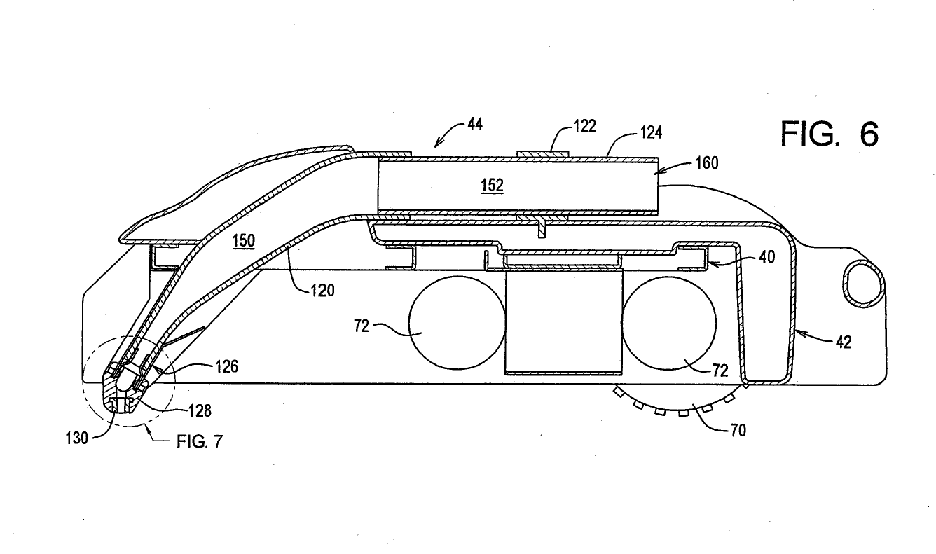

Referring now to FIGS. 5 and 6, it can be seen that the example platform assembly 30 comprises a frame structure 40, a deck structure 42, and inlet assembly 44. The frame structure 40 provides structural integrity to the platform assembly 30. The details of the frame structure 40 are not important so long as the frame structure 40 is sufficiently rigid to allow the platform assembly 30 effectively to bear the loads to which the platform assembly 30 is subjected (e.g., the loads transmitted from the deck structure 42 to the drive system 34). Typically, but not necessarily, the frame structure 40 is formed by welded metal components.

The deck structure 42 forms the surface on which the user 38 stands while the extraction device 22 is in the use mode. The example deck structure 42 further supports the inlet assembly 44 and covers the moving parts of the drive system 34. Again, the details of the deck structure 42 are not important so long as the functions thereof as defined herein are effectively performed. Typically, but not necessarily, the deck structure 42 is made of molded plastic.

The example inlet assembly 44 extends through the deck structure 42 to allow moisture on the surface A to be carried through the hose 26 to the vacuum system 24 by air flowing towards the vacuum system 24.

The example platform assembly 30 further comprises a pair of handle supports 46 and a pair of secondary wheels 48. The handle supports 46 are connected to the frame structure 40 and are configured to support the handle assembly 32 as will be described in further detail below. The example secondary wheels 48 are connected to the frame structure 40 through the handle supports 46. The secondary wheels 48 freely rotate and are sized, dimensioned, and located to engage the surface A when the extraction device 22 is displaced along the surface A in the transportation mode. The secondary wheels 48 reduce friction between the extraction device 22 and the surface A in the transportation mode.

The example handle assembly 32 comprises a pair of upright members 50 rigidly connected to a control support 52. The upright members 50 define handle portions 54 that are located adjacent to the control support 52 during the use mode.

Each of the upright members 50 defines a hinge portion 60 connected to one of the handle supports 46 by a hinge pin 62. In addition, a lock pin 64 extends through the hinge portion 60 of the upright members 50 and into one of a plurality of lock holes 66 formed in each of the handle supports 46. By displacing the lock pins 64 out of the lock holes 66, the upright members 50 may be rotated about a hinge axis defined by the hinge pins 62 relative to the platform assembly 30 between the use and folded configurations as illustrated by a comparison of FIGS. 2 and 3. Inserting the lock pins 64 into selected lock holes 66 allows the extraction device 22 to be locked into either the use configuration or the folded configuration.

As perhaps best shown in FIG. 5, the example drive system 34 comprises first and second drive wheels 70a and 70b operatively connected to first and second drive motors 72a and 72b, respectively, by a transmission assembly 74. The transmission assembly 74 operatively connects the first and second drive motors 72a and 72b to first and second drive sprockets 80a and 80b. The first and second drive sprockets 80a and 80b are in turn connected to first and second drive gears 82a and 82b by first and second drive chains 84a and 84b, respectively. The first and second drive gears 82a and 82b are rigidly connected to first and second drive axles 86a and 86b. The drive axles 86a and 86b are in turn rigidly connected to the drive wheels 70a and 70b. A plurality of drive bearings 88 support the drive axles 86a and 86b along a drive axis for axial rotation relative to the frame structure 40.

The drive motors 72a and 72b are operatively connected to the control system 36 such that the user 38 may cause the drive motors 72a and 72b to drive the drive wheels 70a and 70b to change a direction of travel of the extraction device 22. In particular, the control system 36 comprises a control box 90 that supports a joystick member 92 that is operatively connected to control electronics 94. The control electronics 94 are in turn operatively connected to the drive motors 72a and 72b.

The control electronics 94 convert movement of the joystick member 92 into movement of the extraction device 22. Pushing the joystick member 92 forward causes the drive motors 72a and 72b to rotate both of the drive wheels 70a and 70b in a forward direction F1 to cause the extraction device 22 to move along a forward vector F2 as shown in FIG. 2. On the other hand, FIG. 2 shows that pulling the joystick member 92 back causes the drive motors 72a and 72b to rotate both of the drive wheels 70a and 70b in a reverse direction R1 to cause the extraction device 22 to move along a reverse vector R2.

FIG. 1 illustrates that pushing the joystick member 92 to the right side causes the drive motors 72a and 72b to rotate or pivot the left drive wheel 70a in the first forward direction F1 and the right drive wheel 70b in the first reverse direction R1 to cause the extraction device 22 to move in a right lateral direction L1. Similarly, pushing the joystick member 92 to the left side causes the drive motors 72a and 72b to rotate or pivot the right drive wheel 70a in the first forward direction F1 and the left drive wheel 70a in the first reverse direction R1 to cause the extraction device 22 to move in a left lateral direction L2.

Similarly, pushing the joystick member 92 to the forward left, forward right, back left, and back right will cause the extraction device 22 to move in forward left, forward right, reverse left, and reverse right vectors. The design of the control electronics 94 is well within the skill of one of ordinary skill in the art and need not be described herein in detail.

Turning now to FIG. 6, the construction and operation of the inlet assembly 44 will now be described in further detail. The inlet assembly 44 comprises an inlet housing 120 that is supported by the deck structure 42. The inlet assembly 44 further comprises an inlet support 122 that maintains an inlet pipe 124 in a fixed position relative to the inlet housing 120. An inlet coupler 126 maintains an inlet bracket 128 in a fixed position relative to the inlet housing 120. The inlet bracket 128 supports an inlet member 130 relative to the inlet housing 120. Coupler screws 132 extend through the inlet member 130 to secure the inlet member 130 relative to the inlet bracket 128.

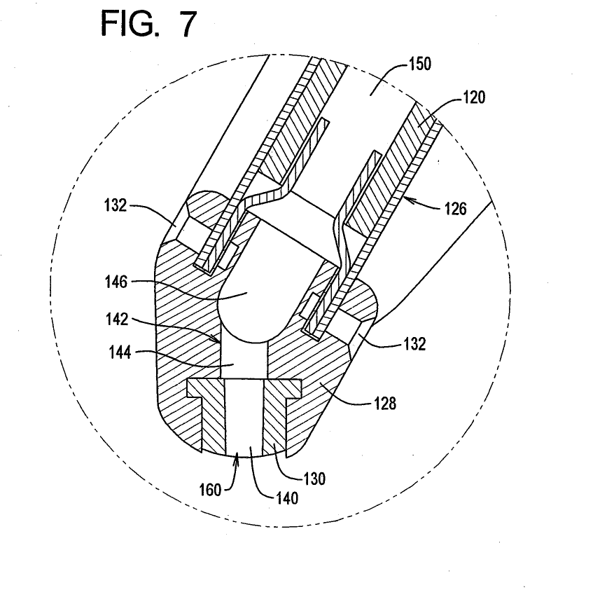

Referring now to FIGS. 5 and 7, it can be seen that the example inlet member 130 defines a plurality of inlet openings 140 (FIG. 5) in fluid communication with an inlet plenum 142. The inlet coupler 128 is milled such that the inlet plenum 142 comprises an inlet plenum comprising a first plenum portion 144 and a second plenum portion 146 in fluid communication with each other. The first plenum portion 144 is in fluid communication with the inlet openings 140, while the second plenum portion 146 is in fluid communication with a housing chamber 150 defined by the inlet housing 120. The housing chamber 150 is in turn in fluid communication with a pipe chamber 152 defined by the inlet pipe 124.

The inlet opening 140, inlet plenum portions 142 and 144, housing chamber 150, and pipe chamber define an inlet passageway 160. When a vacuum is established by the vacuum system 24, air is drawn through the inlet opening 140 and along the inlet passageway 160 and to the vacuum system 24.

Referring for a moment back to the use mode, FIG. 2 illustrates that the drive wheels 70a and 70b and inlet member 130 engage the surface A. With the user 38 standing on the platform assembly 30, the user's weight is transferred to the drive wheels 70a and 70b and the inlet member 130. The user's weight thus applies a downward force on the surface A at the inlet member 130 that squeezes fluids out of the materials defining the surface A.

Accordingly, as fluids are squeezed out of the materials defining the surface A, a stream of air drawn through the inlet opening 140 by the vacuum system 24 entrains these fluids such that the fluids are also carried to the vacuum system 24. The fluids can be removed from the stream of air by the vacuum system 24 (e.g., wet/dry vacuum) and/or, possibly, ancillary equipment such as heaters, dehumidifiers, and the like.

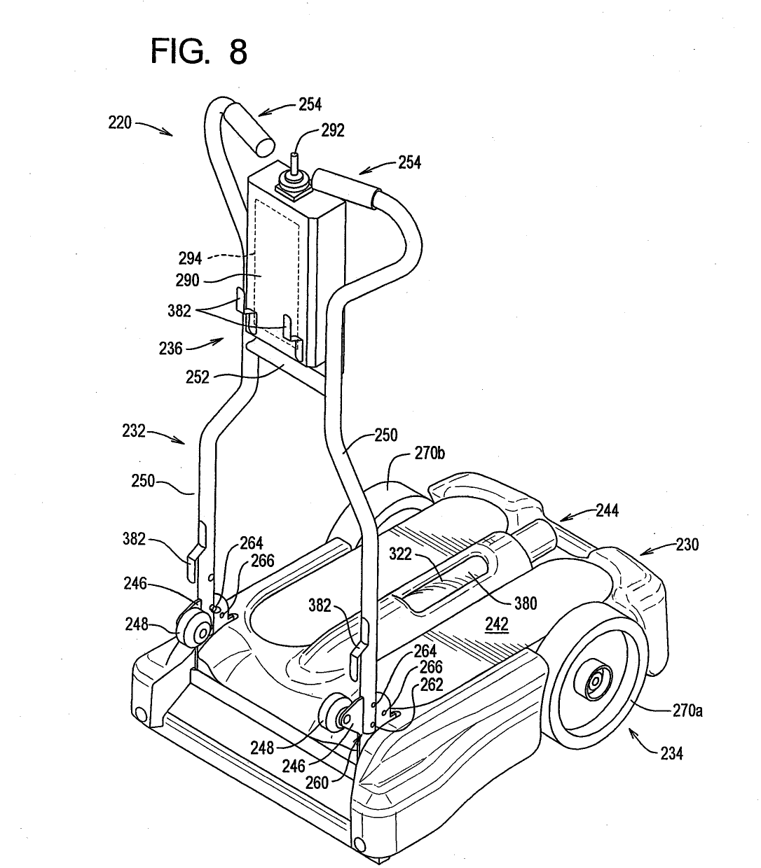

Referring initially to FIGS. 8-12 of the drawing, depicted therein is a second example extraction device 220 constructed in accordance with, and embodying, the principles of the present invention. Like the first example extraction device 22 described above, the second example extraction device 220 is adapted to be used as part of an extraction system comprising a vacuum system and a vacuum hose. The vacuum system and hose are or may be conventional and may be used in substantially the same manner as the vacuum system 24 and vacuum hose 26 described above.

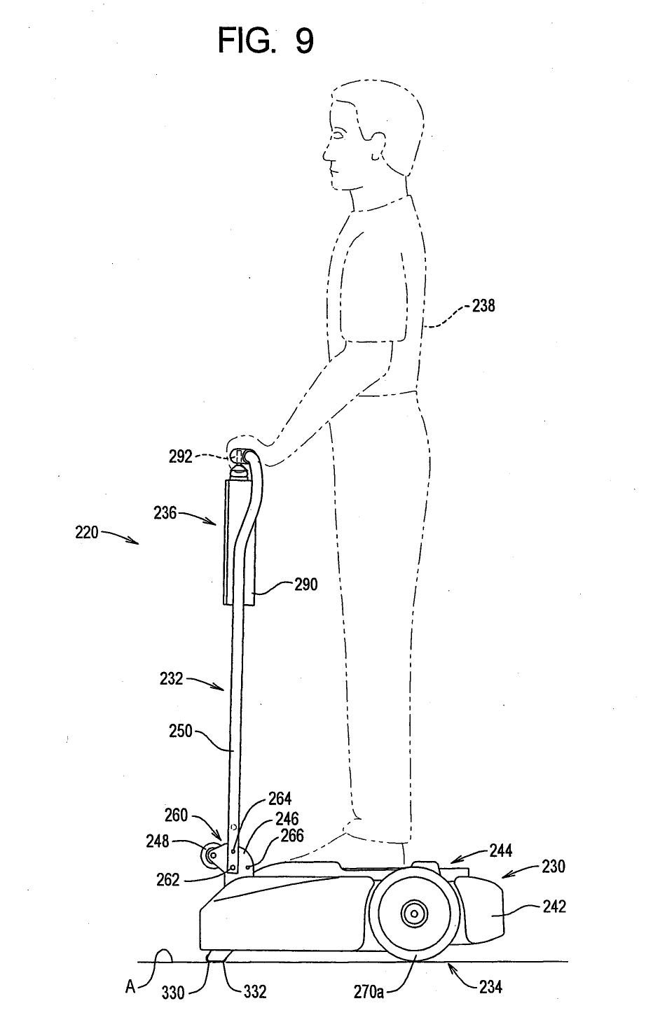

The second example extraction device 220 comprises a platform assembly 230, a handle assembly 232, a drive system 234, and a control system 236. The example extraction device 220 is shown in FIG. 9 in a use configuration. In this use configuration, the extraction device 220 may be placed in a use mode in which a user 238 stands on the platform assembly 230 and grips the handle assembly 232 while operating the control system 236 to cause the drive system 234 to displace the extraction device 220 along a surface A. When connected to the vacuum system by the hose, liquids are extracted from flooring materials defining the surface A.

As with the first extraction device 22 described above, the second example extraction device 220 may also be used in a folded configuration in which an angle between the handle assembly 232 and the platform assembly 230 is changed. In this folded configuration, the extraction device 220 may operated in a storage mode in which the device 220 effectively occupies a volume that is significantly smaller than that occupied by the extraction device 220 in the use configuration. When placed in the storage configuration, the extraction device 220 may be stored more conveniently than in the use configuration. Also, when placed in the folded configuration, the extraction device 220 may be operated in a transportation mode in which the device 220 may be easily displaced along the surface A while not operating.

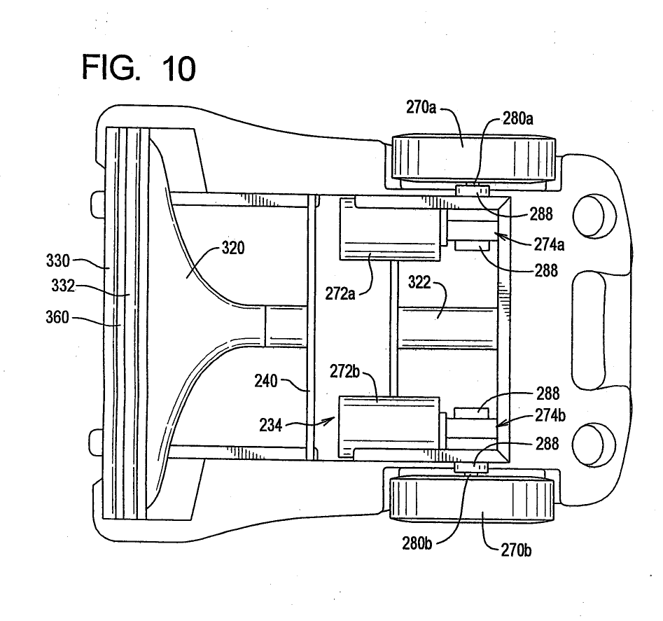

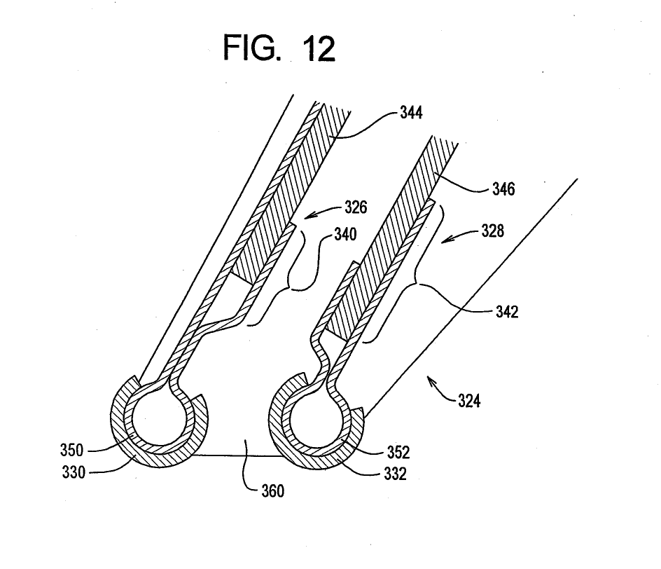

Referring now to FIGS. 10 and 12, it can be seen that the example platform assembly 230 comprises a frame structure 240, a deck structure 242, and inlet assembly 244. The frame structure 240 provides structural integrity to the platform assembly 230. The details of the frame structure 240 are not important so long as the frame structure 240 is sufficiently rigid to allow the platform assembly 230 effectively to bear the loads to which the platform assembly 230 is subjected (e.g., the loads transmitted from the deck structure 242 to the drive system 234). Typically, but not necessarily, the frame structure 240 is formed by welded metal components.

The deck structure 242 forms the surface on which the user 238 stands while the extraction device 220 is in the use mode. The example deck structure 242 further supports the inlet assembly 244 and covers the moving parts of the drive system 234. Again, the details of the deck structure 242 are not important so long as the functions thereof as defined herein are effectively performed. Typically, but not necessarily, the deck structure 242 is made of molded plastic.

The example inlet assembly 244 extends through the deck structure 242 to allow moisture on the surface A to be carried through the hose to the vacuum system by air flowing towards the vacuum system.

The example platform assembly 230 further comprises a pair of handle supports 246 and a pair of secondary wheels 248. The handle supports 246 are connected to the frame structure 240 and are configured to support the handle assembly 232 as will be described in further detail below. The example secondary wheels 248 are connected to the frame structure 240 through the handle supports 246. The secondary wheels 248 freely rotate and are sized, dimensioned, and located to engage the surface A when the extraction device 220 is displaced along the surface A in the transportation mode. The secondary wheels 248 reduce friction between the extraction device 220 and the surface A in the transportation mode.

The example handle assembly 232 comprises a pair of upright members 250 rigidly connected to a control support 252. The upright members 250 define handle portions 254 that are located adjacent to the control support 252 during the use mode.

Each of the upright members 250 defines a hinge portion 260 connected to one of the handle supports 246 by a hinge pin 262. In addition, a lock pin 264 extends through the hinge portion 260 of the upright members 250 and into one of a plurality of lock holes 266 formed in each of the handle supports 246. By displacing the lock pins 264 out of the lock holes 266, the upright members 250 may be rotated about a hinge axis defined by the hinge pins 262 relative to the platform assembly 230 between the use and folded configurations as described above with reference to the first example extraction device 22. Inserting the lock pins 264 into selected lock holes 266 allows the extraction device 220 to be locked into either the use configuration or the folded configuration.

As perhaps best shown in FIG. 10, the example drive system 234 comprises first and second drive wheels 270a and 270b operatively to first and second drive motors 272a and 272b, respectively, by first and second transmission assemblies 274a and 274b. The transmission assemblies 274a and 274b operatively connect the first and second drive motors 272a and 272b to the first and second drive axles 280a and 280b. The drive axles 280a and 280b are in turn rigidly connected to the drive wheels 270a and 270b. A plurality of drive bearings 288 support the drive axles 280a and 280b along a drive axis for axial rotation relative to the frame structure 240.

The drive motors 272a and 272b are operatively connected to the control system 236 such that the user 238 may cause the drive motors 272a and 272b to drive the drive wheels 270a and 270b to move the extraction device 220 and in particular to steer or otherwise change a direction of travel of the extraction device 220. In particular, the control system 236 comprises a control box 290 that supports a joystick member 292 that is operatively connected to control electronics 294. The control electronics 294 are in turn operatively connected to the drive motors 272a and 272b.

The control electronics 294 convert movement of the joystick member 292 into movement of the extraction device 220. Pushing the joystick member 292 forward causes the drive motors 272a and 272b to rotate both of the drive wheels 270a and 270b in a forward direction to cause the extraction device 220 to move along a forward vector. On the other hand, pulling the joystick member 292 back causes the drive motors 272a and 272b to rotate both of the drive wheels 270a and 270b in a reverse direction to cause the extraction device 220 to move along a reverse vector.

Pushing the joystick member 292 to the right side causes the drive motors 272a and 272b to rotate or pivot the left drive wheel 270a in the first forward direction and the right drive wheel 270b in the first reverse direction to cause the extraction device 220 to move in a right lateral direction. Similarly, pushing the joystick member 292 to the left side causes the drive motors 272a and 272b to rotate or pivot the right drive wheel 220b in the first forward direction and the left drive wheel 270a in the first reverse direction to cause the extraction device 220 to move in a left lateral direction.

Similarly, pushing the joystick member 292 to the forward left, forward right, back left, and back right will cause the extraction device 220 to move in forward left, forward right, reverse left, and reverse right vectors. The design of the control electronics 294 is well within the skill of one of ordinary skill in the art and need not be described herein in detail.

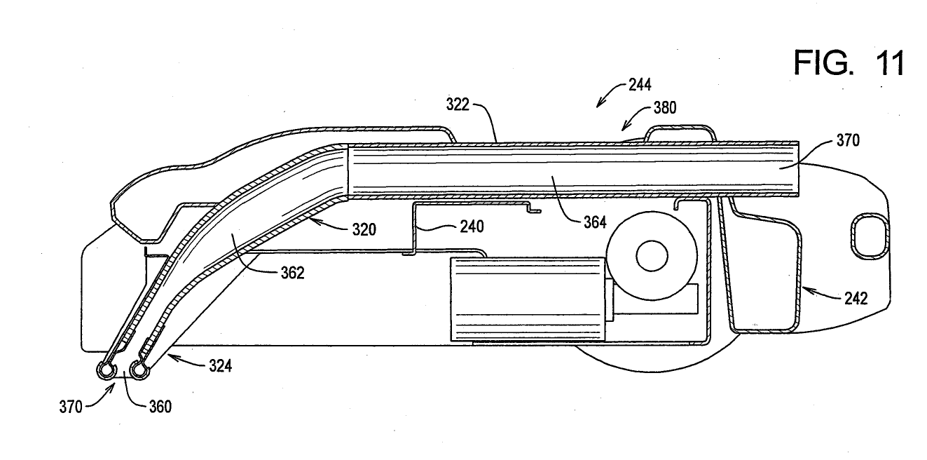

Turning now to FIGS. 11 and 12, the construction and operation of the inlet assembly 244 will now be described in further detail. The inlet assembly 244 comprises an inlet housing 320 that is supported by the deck structure 242. The inlet assembly 244 further comprises an inlet pipe 322 that is held in a fixed position relative to the inlet housing 320.

As perhaps best shown in FIG. 12, an inlet bracket 324 comprises first and second bracket portions 326 and 328 that supports first and second inlet members 330 and 332 relative to the inlet housing 320. In particular, the bracket portions 326 and 328 comprises first and second engaging portions 340 and 342 that rigidly engage front and rear walls 344 and 346 of the inlet housing 320.

The first and second bracket portions further comprise rounded portions 350 and 352. The first and second inlet members 330 and 332 have a generally circular cross-sectional shape that is sized and dimensioned to allow the inlet members 330 and 332 to be detachably attached to the rounded portions 350 and 352. The inlet members 330 and 332 may be made of a material that reduces friction between the rounded portions 350 and 352 and the surface A. The inlet members 330 and 332 may be subject to wear, and thus may be replaced as necessary by detaching them from the rounded portions 350 and 352 and replacing them with new inlet members 330 and 332.

The example inlet members 330 and 332 define an inlet opening 360 (FIGS. 10 and 11) in fluid communication with a housing chamber 362 defined by the inlet housing 320. The housing chamber 362 is in turn in fluid communication with a pipe chamber 364 defined by the inlet pipe 322.

The inlet opening 360, housing chamber 362, and pipe chamber 364 define an inlet passageway 370. When a vacuum is established by the vacuum system, air is drawn through the inlet opening 360 and along the inlet passageway 370. The vacuum hose is connected to the inlet pipe 322 such that the vacuum system is in fluid communication with the inlet passageway 370.

As shown in FIG. 9, the drive wheels 270a and 270b and inlet members 330 and 332 engage the surface A. With the user 238 standing on the platform assembly 230, the user's weight is transferred to the drive wheels 270a and 270b and the inlet members 330 and 332. The user's weight thus applies a downward force on the surface A at the inlet members 330 and 332 that squeezes fluids out of the materials defining the surface A.

As fluids are squeezed out of the materials defining the surface A, a stream of air is drawn through the inlet opening 360 by the vacuum system; the stream of air entrains these fluids such that the fluids are also carried through the inlet passageway 370 to the vacuum system. The fluids can be removed from the stream of air by the vacuum system (e.g., wet/dry vacuum) and/or, possibly, ancillary equipment such as heaters, dehumidifiers, and the like.

In the example extraction device 220, the inlet pipe 322 is formed of a clear material. In addition, an opening 380 is formed in the deck structure 242 that allows the user to see the inlet pipe 322 and thus into the pipe chamber 364. The user can thus monitor the flow of fluids through the pipe chamber 364 and thus determine when the extraction process is complete.

In addition, in the example extraction device 220, two or more cord brackets 382 are adhered to the handle assembly 232 to allow storage of electrical cords. In particular, two such brackets are secured to the control box 290, and one is attached to each of the upright members 250.

Given the foregoing, it should be apparent that the present invention may be embodied in forms other than those described above. The scope of the present invention should thus be determined by the claims appended hereto and not the foregoing detailed descriptions of example embodiments of the present invention.

What is claimed is:

1. A system for applying a vacuum to a floor structure, comprising:
a vacuum system for creating at least a partial vacuum;
a vacuum hose operatively connected to the vacuum system; and
a vacuum accessory comprising
a platform assembly comprising
at least one inlet opening directed to a portion of the floor structure, and
an outlet opening operatively connected to the vacuum hose; and
a drive system comprising a control member and first and second drive wheels; whereby
displacement of the control member causes movement of the first and second drive wheels which in turn causes the platform assembly to move in at least one of a forward direction, a reverse direction, a first pivot direction, and a second pivot direction; and
as the platform assembly moves in at least one of a forward direction, a reverse direction, a first pivot direction, and a second pivot direction, the inlet opening moves along a path relative to the floor structure.

2. A system as recited in claim 1, in which the vacuum accessory further comprises:
an inlet assembly comprising
an inlet housing defining a housing chamber, where the inlet housing is supported by the deck structure,
an inlet pipe defining a pipe chamber and the outlet opening, where the inlet pipe is supported in a fixed position relative to the inlet housing, and
an inlet member defining a plurality of inlet openings, where the inlet member is supported in a fixed position relative to the inlet housing; whereby
an inlet passageway extends through the inlet openings, the housing chamber, the pipe chamber, and the outlet opening to the vacuum hose; and
in a use mode, the first and second drive wheels and the inlet member are in contact with the floor structure.

3. A system as recited in claim 1, further comprising a handle assembly extending from the platform assembly, where the handle assembly supports the control member.

4. A system as recited in claim 1, in which:
the platform assembly further comprises at least one secondary wheel; and
in a transport mode, the at least one secondary wheel engages the floor surface to facilitate movement of the platform assembly along the floor surface.

5. A system as recited in claim 1, in which:
the first and second drive wheels are supported by the platform assembly such that the first and second drive wheels engage the floor surface; and
the control member is a joystick arranged such that the user standing on the platform assembly can displace the joystick in one or more of a forward direction, a reverse direction, a first side direction, and a second side direction; whereby
displacement of the joystick in
the forward direction causes the platform assembly to move in the forward direction;
the reverse direction causes the platform assembly to move in the reverse direction;
the first side direction causes the platform assembly to move in the first pivot direction; and
the second side direction causes the platform assembly to move in the second pivot direction.

6. A platform assembly for allowing a user to extract fluids from a floor structure, comprising:
a deck structure defining a surface on which the user stands;
a frame structure supporting the deck structure and at least one drive wheel for propelling the platform assembly;
an inlet assembly comprising
an inlet housing defining a housing chamber, where the inlet housing is supported by the deck structure,
an inlet pipe defining a pipe chamber, where the inlet pipe is supported in a fixed position relative to the inlet housing, and
an inlet member defining a plurality of inlet openings, where the inlet member is supported in a fixed position relative to the inlet housing; whereby
an inlet passageway extends through the inlet openings, the housing chamber, and the pipe chamber; and
in a use mode, the at least one drive wheel and the inlet member are in contact with the floor structure.

7. A platform assembly as recited in claim 6, in which the inlet assembly further comprises:
an inlet coupler, where the inlet coupler is supported in a fixed position relative to the inlet housing; and
an inlet bracket, where
the inlet coupler is supported in a fixed position relative to the inlet coupler, and
the inlet coupler supports the inlet member.

8. A platform assembly as recited in claim 7, in which the inlet coupler defines a plenum in fluid communication with the housing chamber and the inlet openings.

9. A platform assembly as recited in claim 7, in which the inlet bracket is supported in a fixed relationship with the frame structure.

10. A platform assembly as recited in claim 6, in which the inlet assembly further comprises an inlet support that maintains the inlet pipe in a fixed position relative to the inlet housing.

11. A system for extracting invasive liquids from a floor structure, comprising:
a platform assembly;
a handle assembly extending from the platform assembly;
a drive system comprising
first and second drive wheels supported by the platform assembly, and
a control member supported by the handle assembly; whereby
displacement of the control member causes the first and second drive wheels to rotate to cause the platform assembly to move in at least one of a forward direction, a reverse direction, a first pivot direction, and a second pivot direction.

12. A system as recited in claim 11, in which the drive system further comprises control electronics, where the control electronics convert movement of the control member into movement of the first and second drive wheels.

13. A system as recited in claim 12, in which the drive system further comprises first and second drive motors, where the control electronics operate first and second drive motors.

14. A system as recited in claim 13, in which the drive system further comprises a transmission system operatively connected between the first and second drive motors and the first and second drive wheels.

15. A system as recited in claim 11, in which the control member is a joystick configured such that displacing the joystick forward causes the platform assembly to move in the forward direction, displacing the joystick in reverse causes the platform assembly to move in the reverse direction, displacing the joystick to a first side direction causes the platform assembly to move in the first pivot direction, and displacing the joystick to a second side direction causes the platform assembly to move in the second pivot direction.

16. A drive system for allowing a user standing on a platform assembly to displace the platform assembly along a floor surface, comprising:
at least first and second drive wheels supported by the platform assembly such that the first and second drive wheels engage the floor surface; and
a joystick arranged such that the user standing on the platform assembly can displace the joystick in one or more of a forward direction, a reverse direction, a first side direction, and a second side direction; whereby
displacement of the joystick in
the forward direction causes the platform assembly to move in the forward direction;
the reverse direction causes the platform assembly to move in the reverse direction;
the first side direction causes the platform assembly to move in the first pivot direction; and
the second side direction causes the platform assembly to move in the second pivot direction.

17. A system as recited in claim 16, in which the drive system further comprises control electronics, where the control electronics convert movement of the joystick into movement of the first and second drive wheels.

18. A system as recited in claim 18, in which the drive system further comprises first and second drive motors, where the control electronics operate first and second drive motors.

19. A system as recited in claim 18, in which the drive system further comprises a transmission system operatively connected between the first and second drive motors and the first and second drive wheels.

20. A system as recited in claim 16, further comprising a handle assembly operatively connected to the platform assembly, where the handle assembly supports the joystick relative to the user standing on the platform assembly can displace the joystick.

21. A method of applying a vacuum to a floor structure, comprising the steps of:
providing a vacuum system for creating at least a partial vacuum;
providing a platform assembly defining
at least one inlet opening directed to a portion of the floor structure, and
an outlet opening; and
operatively connecting the vacuum hose to the vacuum system and the outlet opening;
providing a drive system comprising a control member and first and second drive wheels;
operatively connecting the control member and the first and second drive wheels such that displacing the control member causes rotation of the first and second drive wheels;
supporting the first and second wheels on the platform assembly and engaging the first and second wheels with the floor structure such that rotation of the first and second drive wheels causes the platform assembly to move in at least one of a forward direction, a reverse direction, a first pivot direction, and a second pivot direction; and
displacing the control member such that the platform assembly moves in at least one of a forward direction, a reverse direction, a first pivot direction, and a second pivot direction relative to the floor structure to cause the inlet opening to move along a path relative to the floor structure.

22. A method as recited in claim 21, further comprising the steps of:
providing an inlet assembly comprising an inlet housing defining a housing chamber, an inlet pipe defining a pipe chamber and the outlet opening, and an inlet member defining a plurality of inlet openings;
supporting the inlet housing on the platform assembly;
supporting the inlet pipe in a fixed position relative to the inlet housing;
supporting the inlet member in a fixed position relative to the inlet housing, where an inlet passageway extends through the inlet openings, the housing chamber, the pipe chamber, and the outlet opening to the vacuum hose; and
when the first and second drive wheels and the inlet member are in contact with the floor structure, operating the platform assembly in a use mode.

23. A method as recited in claim 21, further comprising the steps of:
providing a handle assembly;
arranging the handle assembly such that the handle assembly extends from the platform assembly; and
supporting control member on the handle assembly.

24. A method as recited in claim 21, further comprising the step of:
providing at least one secondary wheel;
operatively connecting the at least one secondary wheel assembly to the platform assembly; and
when the at least one secondary wheel engages the floor surface, operating the platform assembly in a transport mode to facilitate movement of the platform assembly along the floor surface.

25. A method as recited in claim 21, further comprising the steps of:
supporting the first and second drive wheels on the platform assembly such that the first and second drive wheels engage the floor surface;
providing a joystick to form the control member;
arranging the joystick such that the user standing on the platform assembly can displace the joystick in one or more of a forward direction, a reverse direction, a first side direction, and a second side direction; whereby
displacement of the joystick in
the forward direction causes the platform assembly to move in the forward direction,
the reverse direction causes the platform assembly to move in the reverse direction,
the first side direction causes the platform assembly to move in the first pivot direction, and
the second side direction causes the platform assembly to move in the second pivot direction.
